(19) United States
(12) Patent Application Publication
(10) Pub. No.: US 2026/0021866 A1
(43) Pub. Date: Jan. 22, 2026

(54) VENT SEAL DEVICE FOR A BICYCLE

(71) Applicant: SRAM, LLC, CHICAGO, IL (US)

(72) Inventor: SHU WEI HO, TAICHUNG CITY (TW)

(73) Assignee: SRAM, LLC, CHICAGO, IL (US)

(21) Appl. No.: 19/262,919

(22) Filed: Jul. 8, 2025

Related U.S. Application Data
(60) Provisional application No. 63/672,882, filed on Jul. 18, 2024.

(51) Int. Cl. B62K 25/08

(52) U.S. Cl. CPC B62K 25/08; B62K 2201/08

(57) ABSTRACT

A suspension component for a bicycle includes a first suspension element and a second suspension element movable relative to the first suspension element. A pressure chamber is provided biasing the first suspension element apart from the second suspension element. A vent seal is operable to control fluid communication from the pressure chamber. A fastener is attachable to the first suspension element and movable between a first position wherein the fastener is retained in the first suspension element and maintains the vent seal in a sealed position wherein fluid communication from the pressure chamber is blocked; and a second position wherein the fastener is retained in the first suspension element and facilitates movement of the vent seal to an unsealed position wherein fluid communication from is pressure chamber is allowed.

This application claims the benefit of U.S. Provisional Patent Application 63/672,882, filed Jul. 18, 2024, the contents of which are hereby incorporated by reference in its entirety.

### FIELD

The present disclosure relates to bicycle components, and more specifically to suspension components for bicycles.

### BACKGROUND

Bicycles are known to have suspension components. Suspension components are useful in various applications for cushioning impacts, isolating a sprung mass including a rider from vibrations and terrain features, and maintaining tire contact with the riding surface. Suspension components may generally contain pressurized fluids, including air and oils. In order to ensure the safety of users and service personnel, features that reduce the likelihood of safety incidents are desired.

As such, there is a need for suspension arrangements that facilitate allow installation, disassembly, and general service operations to be performed safely.

### SUMMARY

An object of this disclosure is to describe various suspension arrangements to manage contained pressures. Suspension components may be provided with one or more springs, including air springs. The described suspension arrangements may advantageously provide a controlled release of stored pressure, even accounting for oversights in or improper ordering of service procedures. A vent seal device may be employed to achieve these goals.

One aspect provides a suspension component for a bicycle, the suspension component including a first suspension element; a second suspension element movable relative to the first suspension element; a pressure chamber biasing the first suspension element apart from the second suspension element; a vent seal operable to control fluid communication from the pressure chamber; and a fastener attachable to the first suspension element. The fastener is movable between: a first position wherein the fastener is retained in the first suspension element and maintains the vent seal in a sealed position wherein fluid communication from the pressure chamber is blocked; and a second position wherein the fastener is retained in the first suspension element and facilitates movement of the vent seal to an unsealed position wherein fluid communication from is pressure chamber is allowed.

Another aspect provides a vent seal device for an air spring system, the vent seal device including an air spring shaft assembly defining an axis and a vent seal movable along the axis between: a sealed position wherein the air spring shaft is sealed by the vent seal; and an unsealed position wherein the air spring shaft can fluidly communicate past the vent seal. A fastener is attachable to the vent seal device and movable along the axis between: a first position wherein the fastener is retained in the air spring shaft assembly and maintains the vent seal in the sealed position; and a second position wherein the fastener is retained in the air spring shaft assembly and facilitates movement of the vent seal to the unsealed position.

Yet another aspect provides A suspension component for a bicycle, the suspension component including an upper assembly and a lower assembly movable relative to the upper assembly. A pressure chamber biases the upper assembly apart from the lower assembly and a vent seal is operable to control fluid communication from the pressure chamber. A fastener is attachable to a shaft assembly, wherein the fastener is movable between a first position wherein the fastener is retained in the shaft and maintains the vent seal in a sealed position wherein fluid communication from the pressure chamber is blocked, and a second position wherein the fastener is retained in the shaft assembly and facilitates movement of the vent seal to an unsealed position wherein fluid communication from is pressure chamber is allowed.

### BRIEF DESCRIPTION OF THE DRAWINGS

FIG. 1 is a side view of an example bicycle that can employ any of the example suspension arrangements disclosed herein.

FIG. 2 is a perspective view of an example suspension fork that can be employed on the example bicycle of FIG. 1

FIG. 3 is partial sectional view of the example suspension fork of FIG. 1.

FIG. 4 is an enlarged sectional view of the example suspension fork as indicated by callout V in FIG. 3 with a vent seal device shown in a first state.

FIG. 5 is an enlarged sectional view of the example suspension fork as indicated by callout V in FIG. 3 with the vent seal device of FIG. 4 shown in a second state.

FIG. 6a is an enlarged sectional view of an embodiment of a vent seal device in a first state that may be employed on the example suspension fork of FIG. 2.

FIG. 6b is an enlarged sectional view of an embodiment of a vent seal device in a first state that may be employed on the example suspension fork of FIG. 2.

FIG. 6c is an enlarged sectional view of an embodiment of a vent seal device in a first state that may be employed on the example suspension fork of FIG. 2.

FIG. 7a is an enlarged sectional view of the vent seal device of FIG. 6a in a second state.

FIG. 7b is an enlarged sectional view of the vent seal device of FIG. 6b in a second state.

FIG. 7c is an enlarged sectional view of the vent seal device of FIG. 6c in a second state.

The figures may not be to scale. Instead, the thickness of the layers or regions may be enlarged in the drawings. In general, the same reference numbers will be used throughout the drawing(s) and accompanying written description to refer to the same or like parts.

Other aspects and advantages of the embodiments disclosed herein will become apparent upon consideration of the following detailed description, wherein similar or identical structures may have similar or identical reference numerals.

### DETAILED DESCRIPTION

Reference will now be made in detail to present embodiments of the invention, one or more embodiments of which are illustrated in the accompanying drawings. The detailed description uses numerical and letter designations to refer to features in the drawings. Like or similar designations in the drawings and description have been used to refer to like or similar parts of the invention.

The word “exemplary” is used herein to mean “serving as an example, instance, or illustration.” Any implementation described herein as “exemplary” is not necessarily to be construed as preferred or advantageous over other implementations.

The descriptors used herein, including the terms “first”, “second”, “third”, etc. may be used interchangeably to distinguish one component from another and are not intended to signify location or importance of the individual components. Unless otherwise specified or understood based on their context of use, such descriptors are not intended to impute any meaning of priority or ordering in time but merely as labels for referring to multiple elements or components separately for ease of understanding the disclosed embodiments. In some embodiments, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Various suspension components may be provided with reference to the following disclosure. For example, front suspension forks, rear suspension shocks, seatposts, and various other suspension components are contemplated in connection with the features that follow. Proceeding with the example of front suspension on a bicycle, a front fork typically includes a crown, a steerer tube extending upward from the crown, and two legs extending downward from the crown. Each leg has an upper tube that is connected to the crown and a lower tube that is to be connected to the front wheel. The upper and lower tubes are arranged in a telescopic relationship. In some instances, a damper is disposed in one of the legs and a spring (e.g., an air spring, a coil spring) is disposed in the other leg. The spring enables the front fork to compress or contract when riding over a bump or obstacle, thereby reducing the transmission of shocks and vibrations to the rider, and then returns the fork to an expanded state after the compressive force is removed. In an air spring, pressures contained within a suspension component may be dangerous if suddenly released.

Various suspension components on a bicycle may employ air springs to at least in part provide support for the rider. Such components include front forks, rear shocks, and seatposts that employ one or more air chambers to support the rider. Air springs may generally be provided with at least one positive chamber that provides spring pressure to resist compression. At least one negative chamber may further be provided, where the negative pressure and positive pressure are in equilibrium in an uncompressed state. The positive air spring may include a plurality of positive air chambers. It is desirable that during disassembly, even if all safety protocol is not followed, a user or service personnel will not cause a sudden release of any of the possible air chambers disposed within a suspension component. Such sudden releases of air pressure may present a danger, and thus redundant layers of safety features may be provided to reduce such danger.

Disclosed herein are example suspension components with vent seal devices, which may include vent seal assemblies and vent seals. In various examples, vent seal devices as described herein may be operable to safely release pressure from various suspension components. Vent seal devices generally provide an extra layer of safety to suspension products based on the operation thereof described in this document.

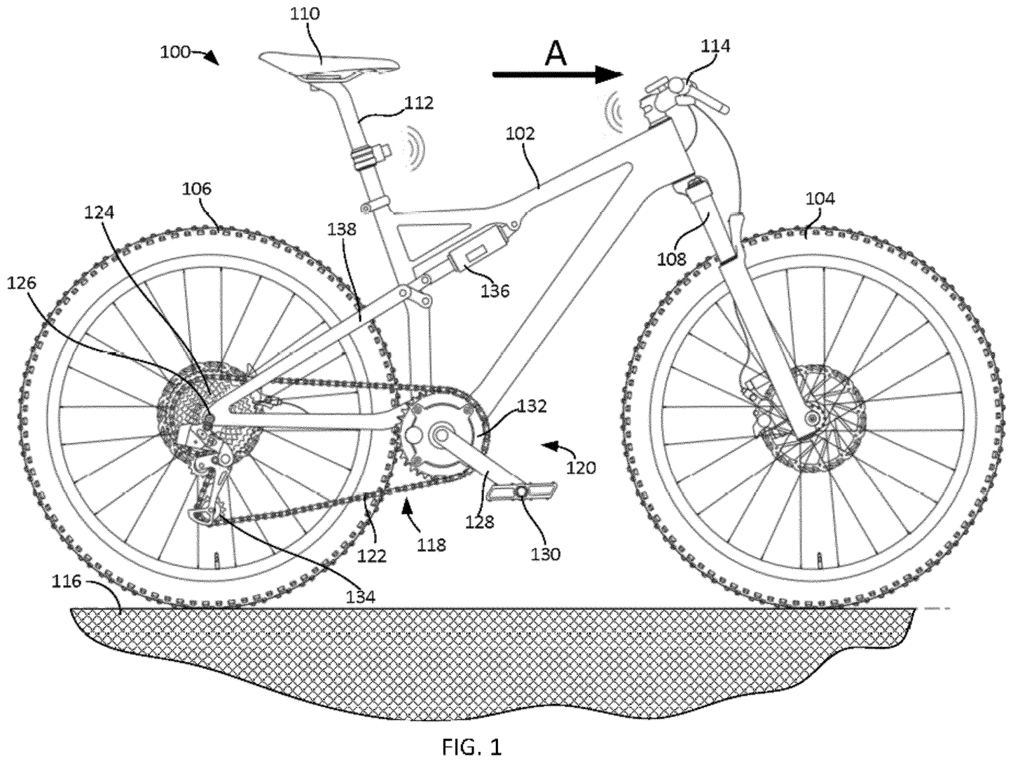

Turning now to the figures, FIG. 1 illustrates one example of a human powered vehicle on which the example front forks disclosed herein may be implemented. In this example, the vehicle is one possible type of bicycle 100, such as a mountain bicycle. In the illustrated example, the bicycle 100 includes a frame 102 and a front wheel 104 and a rear wheel 106 rotatably coupled to the frame 102. In the illustrated example, the front wheel 104 is coupled to the front end of the frame 102 via a front fork 108. A front and/or forward riding direction or orientation of the bicycle 100 is indicated by the direction of the arrow A in FIG. 1. As such, a forward direction of movement for the bicycle 100 is indicated by the direction of arrow A.

In the illustrated example of FIG. 1, the bicycle 100 includes a seat 110 coupled to the frame 102 (e.g., near the rear end of the frame 102 relative to the forward direction A) via a seatpost 112. The bicycle 100 also includes handlebars 114 coupled to the front fork 108 (e.g., near a forward end of the frame 102 relative to the forward direction A) for steering the bicycle 100. The bicycle 100 is shown on a riding surface 116. The riding surface 116 may be any riding surface such as the ground (e.g., a dirt path, a sidewalk, a street, etc.), a man-made structure above the ground (e.g., a wooden ramp), and/or any other surface.

In the illustrated example, the bicycle 100 has a drivetrain 118 that includes a crank assembly 120. The crank assembly 120 is operatively coupled via a chain 122 to a sprocket assembly 124 mounted to a hub 126 of the rear wheel 106. The crank assembly 120 includes at least one, and typically two, crank arms 128 and pedals 130, along with at least one front sprocket, or chainring 132. A rear gear change device 134, such as a derailleur, is disposed at the rear wheel 106 to move the chain 122 through different sprockets of the sprocket assembly 124. Additionally or alternatively, the bicycle 100 may include a front gear change device (not shown) to move the chain 122 through gears on the chainring 132.

The example bicycle 100 includes a suspension system having one or more suspension components. The front fork 108 is or integrates a shock absorber that includes a spring and a damper, disclosed in further detail herein. Further, in the illustrated example, the bicycle 100 includes a rear suspension component 136, which is a shock absorber, referred to herein as the rear shock absorber 136. The rear shock absorber 136 is coupled between two portions of the frame 102, including a rear triangle, also referred to herein as a swing arm 138 coupled to the rear wheel 106. The front fork 108 and the rear shock absorber 136 absorb shocks and vibrations while riding the bicycle 100 (e.g., when riding over rough terrain). In other embodiments, the front fork 108 and/or the rear shock absorber 136 may be integrated into the bicycle 100 in other configurations or arrangements.

Further, in other embodiments, the suspension system may employ only one suspension component (e.g., only the front fork 108) or more than two suspension components (e.g., an additional suspension component on the seatpost 112) in addition to or as an alternative to the front fork 108 and rear shock absorber 136. Generally described, suspension components herein may include a first suspension element and a second suspension element movable relative to the first suspension element. A pressure chamber or other spring is provided to bias the first suspension element apart from the second suspension element, for example along a suspension axis. One of the first suspension element or the second suspension element is connected or connectable to an unsprung portion (i.e. one that is not suspended) of the bicycle 100 while the other is connected or connectable to a sprung portion of the bicycle 100 (i.e. one that is supported by suspension).

While the example bicycle 100 depicted in FIG. 1 is a type of mountain bicycle, the example front forks (and/or lower housings or housings) disclosed herein can be implemented on other types of bicycles. For example, the disclosed front forks may be used on road bicycles, as well as bicycles with mechanical (e.g., cable, hydraulic, pneumatic, etc.) and non-mechanical (e.g., wired, wireless) drive systems. The disclosed front forks can also be implemented on other types of two-wheeled, three-wheeled, and four-wheeled human powered vehicles. Further, the example front forks can be used on other types of vehicles, such as motorized vehicles (e.g., a motorcycle, a car, a truck, etc.).

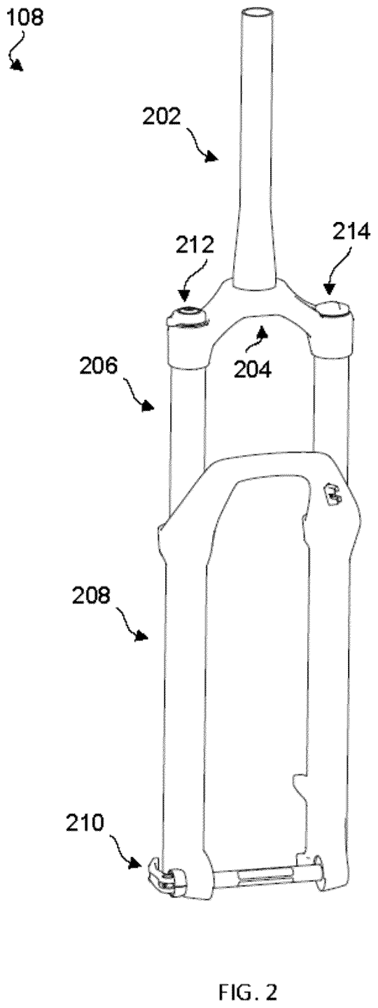

Turning now to FIG. 2, a perspective view of a front fork 108 is provided. The front fork 108 as shown in FIG. 2 generally includes a steerer 202 for attaching to a frame of a bicycle (for example the frame 102 of FIG. 1). The steerer 202 connects with a crown assembly 204. The crown assembly 204 transmit forces between further suspension components to the steerer. For example, the crown assembly 204 transmits steering torque from a rider input through to a wheel (i.e. the front wheel 104 of FIG. 1) connected at a wheel mounting portion 210 and transmits suspension forces through the steerer 202 to the rider. An upper assembly 206 is connected to the crown assembly 204. The upper assembly 206 may comprise one or more upper tubes, for example the two upper tube configuration provided in FIG. 2. In other examples, a single tube configuration may be provided. It should also be appreciated that while the upper assembly 206 and the crown assembly 204 are shown as separate components, they may be at least in part integrally formed. For example, an inverted or upside-down configuration of a fork may have a unitary crown and upper assembly (not shown). A lower assembly 208 is movable relative to the upper assembly 206. The relative movement of the lower assembly 208 and the upper assembly 206 is used to provide suspensioning of the front fork. This relative movement of the lower assembly 208 and the upper assembly 206 may be along an axis with a tube-in-tube configuration as shown in FIG. 2, or may follow a different path, for example with various linkages controlling movement. Although the example in FIG. 2 depicts the upper assembly 206 being received within the lower assembly 208, it should also be appreciated that the lower assembly 208 could be received within the upper assembly 206 as in the case with inverted forks.

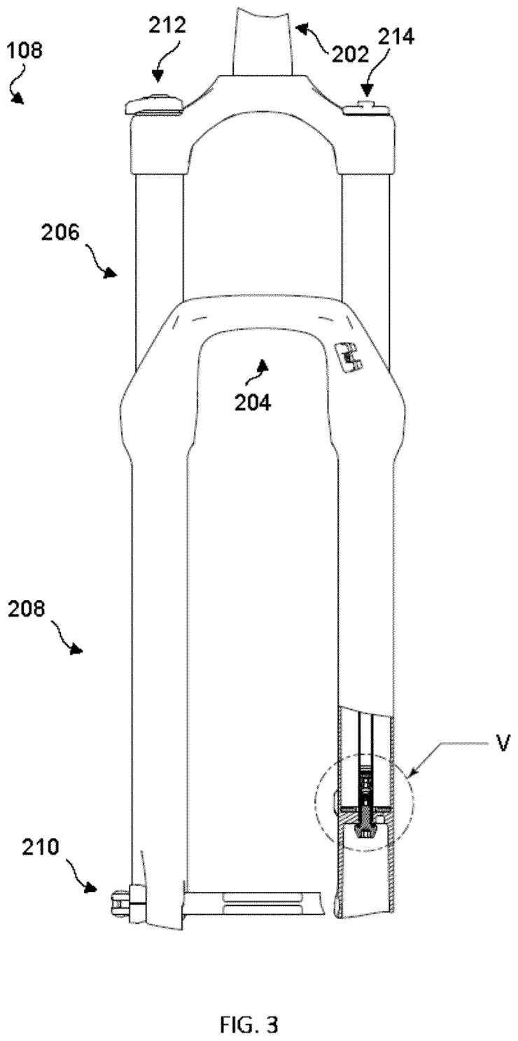

Turning now to FIG. 3, an enlarged frontal view of the front fork 108 of FIG. 2 is provided with a partial sectional view taken near the indicated callout V. As shown in FIG. 3, a damper assembly 212 and a spring assembly 214 are provided. Although shown in separate legs of the front fork 108, it should also be appreciated that the damper assembly 212 and the spring assembly 214 may be incorporated into one leg of a fork, either in a two-leg configuration as shown in FIG. 3 or in a single-leg configuration (not shown). The damper assembly 212 as shown is received in the crown assembly 204, the upper assembly 206 and the lower assembly 208, however, the damper assembly 212 may be provided in any suitable manner to control relative movement between the upper assembly 206 and the lower assembly 208. The spring assembly 214 as shown is received in the crown assembly 204, the upper assembly 206 and the lower assembly 208, however, the spring assembly 214 may be provided in any suitable manner to bias relative movement between the upper assembly 206 and the lower assembly 208. As will be described in greater detail below, the spring assembly 214 may provide various features to facilitate safe disassembly or service of the front fork 108.

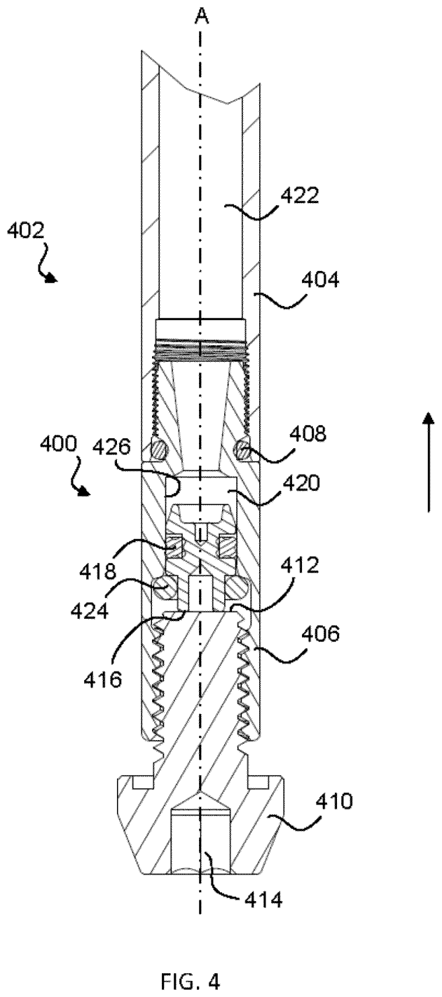

Turning now to FIG. 4, an enlarged sectional view of a vent seal device 400 is shown as would be seen from callout V in FIG. 3. Although the vent seal 400 shown is suitable for use with the front fork 108 in FIG. 3, it should also be appreciated that the vent seal device could also be employed in various other suspension components, including rear shocks and seatposts, such as the rear shock 136 or the seatpost 112 shown in FIG. 1.

Continuing with FIG. 4, the vent seal device 400 is shown in conjunction with an air spring shaft assembly 402. The air spring shaft assembly 402 as shown includes a shaft 404 and an insert 406 removably installed in the shaft 404. The air spring shaft assembly 402 may be generally configured as a piston rod for controlling an air piston (not shown) of the suspension component. The insert 406 and the shaft 404 are sealed by an insert seal 408. The insert seal 408 may also serve to maintain the insert 406 in the shaft 404, for example alone or in conjunction with straight or tapered threading. As shown in FIG. 4, threading between the insert 406 and the shaft 404 may be relatively fine in comparison to provide a relatively high clamping load. It is also contemplated that the features described herein could be included with an air spring shaft assembly 402 that does not include an insert 406, with features of the insert 406 incorporated into the shaft 404. Furthermore, one or more components of the air spring shaft assembly may be integrated with other components of a lower assembly 208 as shown in FIGS. 2 and 3, for example with a fastener 410 directly attachable to a fork lower (not shown)

As shown in FIG. 4, the fastener 410 is configured to threadedly attach to the insert 406 of the air spring shaft assembly 402. However, as explained directly above, the fastener 410 could also thread in to or otherwise be removably attached directly with other components such as the shaft 404. The fastener 410 may have a relatively coarse threading in comparison with that between the insert 406 and the shaft 404 so as to provide a relatively low clamping load and encourage preferential disassembly of the fastener 410 before the insert 406. The fastener 410 as shown in FIG. 4 may be described as being a first position, corresponding generally to an installed position. Although not shown, the fastener 410 may seat against another component of the suspension component to provide thread stretch and mechanically retain its fixing torque. It should also be appreciated that various other fixing methodologies may be employed, including thread locking devices or compounds.

The fastener 410 shown in FIG. 4 includes a fastener operation feature 412 and a fastener user feature 414. The fastener operation feature 412 may be employed for various operations as described below. The fastener user feature 414 provides a user the ability to control the fastener 410, for example to move the fastener 410 between various positions. Positions of the fastener 410 may generally be described along an axis A. The axis A as shown in defined along a longitudinal extent of the air spring shaft assembly 402. The axis A may also correspond to an axis of a suspension component (not shown). For example the axis A may be coaxial with an axis of a suspension component, substantially parallel to such an axis, or offset laterally or angularly from such an axis.

Still referring to FIG. 4, the fastener 410 is shown in its first position, where the fastener 410 is at or near a maximum travel in a first direction D along the axis A. In this first position, the fastener operation feature 412 interfaces with a vent seal operation feature 416 of the vent seal device 400. As shown, the vent seal operation feature 416 is operable to move and maintain a vent seal 418 in various positions, for example the sealed position shown in FIG. 4 corresponding to a sealed and captured state of the vent seal device 400. In the sealed position of FIG. 4, the vent seal device 400 prevents fluid communication through a vent chamber 420. The vent chamber 420 may be provided to control venting and sealing as part of the vent seal device 400 and is generally in fluid communication with a pressure chamber 422. The pressure chamber 422 may be any pressure chamber in conjunction with an air sprung suspension component, including the front fork 108, the rear shock 136, or the seatpost 112 of FIG. 1.

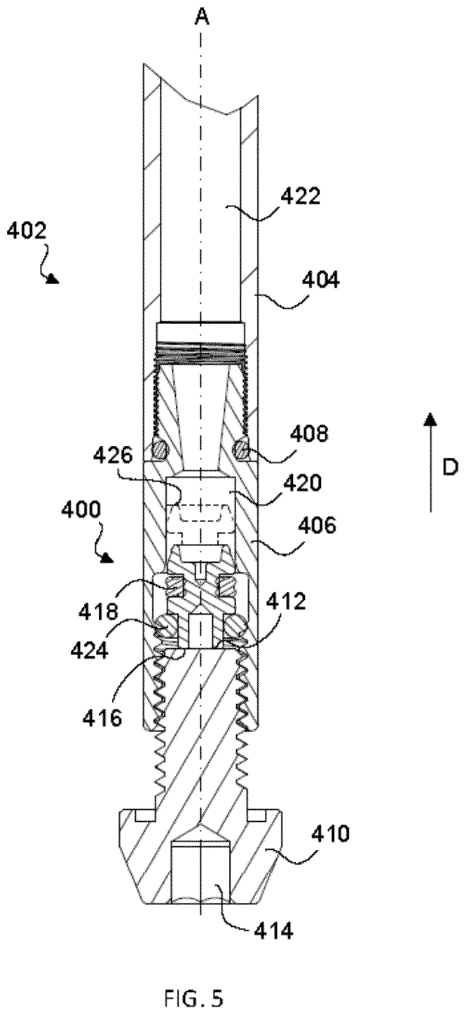

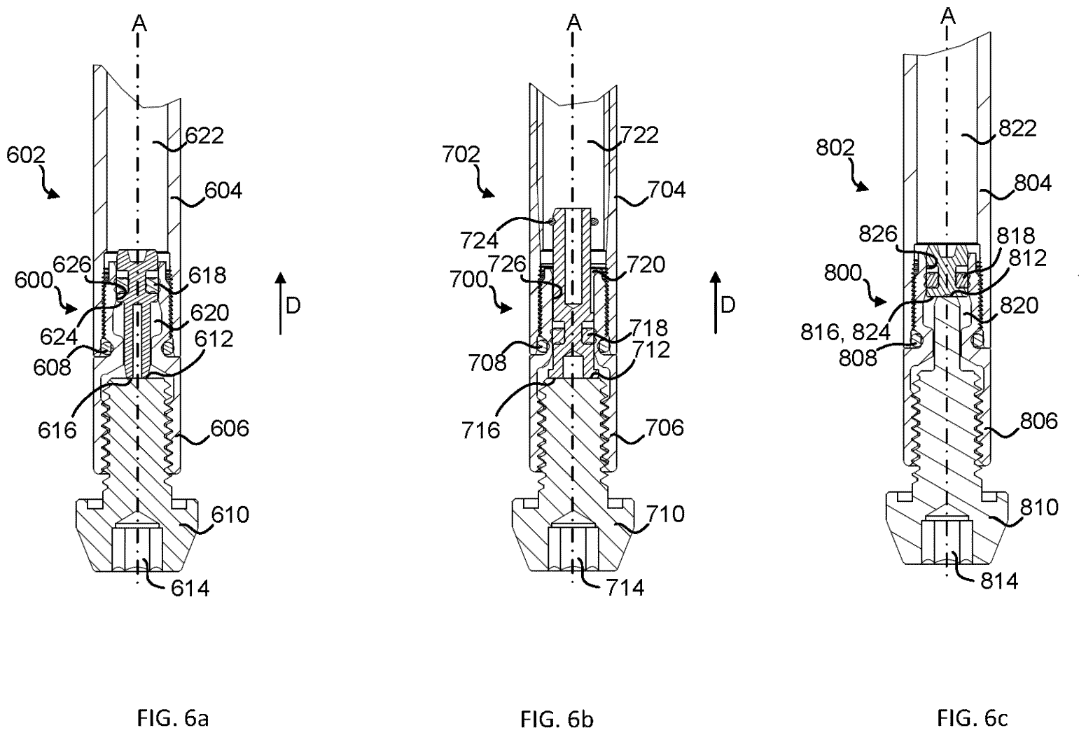

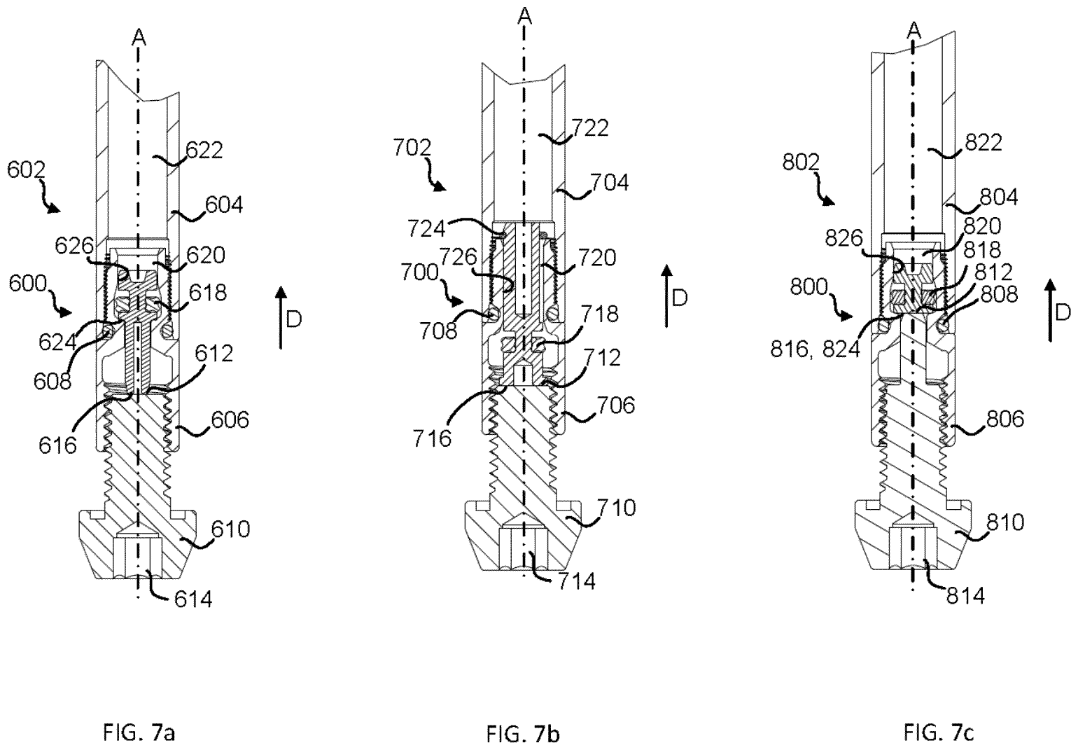

Turning now to FIG. 5, the vent seal device 400 of FIG. 4 is shown in an unsealed position wherein the vent chamber 420 and thus the pressure chamber 422 can fluidly communicate past the vent seal 418. As shown in FIG. 5, a stop feature 424 is provided with the vent seal 418 of the vent seal device 400. The stop feature 424 is generally sized and shaped to retain the vent seal 418, for example even if the fastener 410 were completely removed. As shown in FIG. 5, the stop feature 424 may be sized and shaped such that a minor diameter of the threaded attachment portion for the fastener 410 retains the stop feature 424 as the fastener 410 is removed. However, further examples of the stop feature 424 and related elements will be described in connection with FIGS. 6a, 6b, 6c, 7a, 7b, and 7c below.

Still referring to FIG. 5, as noted with the dashed lines, at least a portion of the vent seal device 400 including the vent seal 418 is displaced opposite the first direction D along the axis A. This displacement may generally occur as a result of biasing air pressure from the pressure chamber 422 communicated through the vent chamber 420 to the vent seal 418. For example, as the fastener 410 is moved opposite the first direction D along the axis A, the fastener operation feature 412 allows corresponding movement of the vent seal 418 through the vent seal operation feature 416 opposite the first direction D along the axis A. Air pressure from the vent chamber 420 then biases vent seal 418 until such pressure can escape past the vent seal 418, as shown in FIG. 5 where the vent seal 418 no longer seals against a shaft seal surface 426. As shown in FIG. 5, pressure from the pressure chamber 422 can safely vent through the vent chamber 420, past the vent seal 418, and through the threaded connection of the fastener 410 while the fastener 410 is still maintained safely in the air spring shaft assembly 402.

Although not shown in FIG. 4 or 5, it should be appreciated that the fastener 410 is also movable to a third position wherein the fastener 410 is free from the air spring shaft assembly 402. For example, the fastener 410 may be completely unthreaded and removed from the air spring shaft assembly 402. In such a case, as described above, the vent seal 418 may be maintained in position, for example with the stop feature 424 and any other corresponding features of the air spring shaft assembly 402.

Turning now to FIGS. 6a and 7a, another example of a vent seal device 600 is provided. It should be understood with this and other examples that various features and elements may be interchanged as appropriate between examples and that features and elements described in connection with one example may be applied to other examples. As shown in FIG. 6a, the vent seal device 600 is provided in connection with an air spring shaft assembly 602 of a suspension component. The air spring shaft assembly 602 includes a shaft 604 and an insert 606, but may also be a unitary component as described above. An insert seal 608 is disposed between the insert 606 and the shaft 604 to provide an airtight seal therebetween. As with other seals described herein, the insert seal 606 may be of any appropriate type, including O-ring seals, X-ring seals, wiper seals, labyrinth seals, or lip seals. A fastener 612 is removably inserted into the air spring shaft assembly 602, and as shown is threadedly connected. The fastener 610 includes a fastener user feature 614, for example a tooled connection or toolless connection for controlling rotation.

The fastener 610 further includes a fastener operation feature 612 for controlling a vent seal operation feature 616 in connection with a vent seal 618. The vent seal 618 is operable to seal with a shaft seal surface 626 of the air spring shaft assembly 602. A vent chamber 620 communicates fluid and pressure to the vent seal 618, for example from a pressure chamber 622 as shown.

Turning to FIG. 7a, a stop feature 624 is provided to retain the vent seal 618 relative to the air spring shaft assembly 602 as the vent seal 618 moves opposite the first direction D along the axis A to the unsealed position shown. In this unsealed position, fluid and pressure can communicate across the vent seal 618 while the fastener 610 is retained safely in place by the air spring shaft assembly 602. Notably, the stop feature 624 of FIG. 7a is provided as an integrated part of the vent seal device 600 to interface directly with the air spring shaft assembly 602.

Turning now to FIGS. 6b and 7b, another example of a vent seal device 700 is provided. As shown in FIG. 6b, the vent seal device 700 is provided in connection with an air spring shaft assembly 702 of a suspension component. The air spring shaft assembly 702 includes a shaft 704 and an insert 706, but may also be a unitary component as described above. An insert seal 708 is disposed between the insert 706 and the shaft 704 to provide an airtight seal therebetween. As with other seals described herein, the insert seal 706 may be of any appropriate type, including O-ring seals, X-ring seals, wiper seals, labyrinth seals, or lip seals. A fastener 712 is removably inserted into the air spring shaft assembly 702, and as shown is threadedly connected. The fastener 710 includes a fastener user feature 714, for example a tooled connection or toolless connection for controlling rotation.

The fastener 710 further includes a fastener operation feature 712 for controlling a vent seal operation feature 716 in connection with a vent seal 718. The vent seal 718 is operable to seal with a shaft seal surface 726 of the air spring shaft assembly 702. A vent chamber 720 communicates fluid and pressure to the vent seal 718, for example from a pressure chamber 722 as shown.

Turning to FIG. 7b, a stop feature 724 is provided to retain the vent seal 718 relative to the air spring shaft assembly 702 as the vent seal 718 moves opposite the first direction D along the axis A to the unsealed position shown. In this unsealed position, fluid and pressure can communicate across the vent seal 718 while the fastener 710 is retained safely in place by the air spring shaft assembly 702. Notably, in FIG. 7b, the stop feature 724 is provided within the pressure chamber 722 to interface with a feature thereon and retain the vent seal 718. As shown, the stop feature 724 is a retaining ring or circlip configuration, but could be substituted with other shown configurations or any other suitable configuration.

Turning now to FIGS. 6c and 7c, another example of a vent seal device 800 is provided. As shown in FIG. 6c, the vent seal device 800 is provided in connection with an air spring shaft assembly 802 of a suspension component. The air spring shaft assembly 802 includes a shaft 804 and an insert 806, but may also be a unitary component as described above. An insert seal 808 is disposed between the insert 806 and the shaft 804 to provide an airtight seal therebetween. As with other seals described herein, the insert seal 806 may be of any appropriate type, including O-ring seals, X-ring seals, wiper seals, labyrinth seals, or lip seals. A fastener 812 is removably inserted into the air spring shaft assembly 802, and as shown is threadedly connected. The fastener 810 includes a fastener user feature 814, for example a tooled connection or toolless connection for controlling rotation.

The fastener 810 further includes a fastener operation feature 812 for controlling a vent seal operation feature 716 in connection with a vent seal 818. The vent seal 818 is operable to seal with a shaft seal surface 826 of the air spring shaft assembly 802. A vent chamber 820 communicates fluid and pressure to the vent seal 818, for example from a pressure chamber 822 as shown.

Turning to FIG. 7c, a stop feature 824 is provided to retain the vent seal 818 relative to the air spring shaft assembly 802 as the vent seal 818 moves opposite the first direction D along the axis A to the unsealed position shown. In this unsealed position, fluid and pressure can communicate across the vent seal 818 while the fastener 810 is retained safely in place by the air spring shaft assembly 802. Notably, in FIG. 7c, the stop feature 824 is integrated with the vent seal operation feature 816 and cooperates with a complimentary surface of the vent chamber 820 to retain the vent seal 818.

The embodiments described herein may be provided with any of the features and elements as shown and described. The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations and/or acts are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that any described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72 (b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

Further aspects are provided by the subject matter of the following clauses:

A suspension component for a bicycle, the suspension component comprising a first suspension element; a second suspension element movable relative to the first suspension element; a pressure chamber biasing the first suspension element apart from the second suspension element; a vent seal operable to control fluid communication from the pressure chamber; and a fastener attachable to the first suspension element, wherein the fastener is movable between: a first position wherein the fastener is retained in the first suspension element and maintains the vent seal in a sealed position wherein fluid communication from the pressure chamber is blocked; and a second position wherein the fastener is retained in the first suspension element and facilitates movement of the vent seal to an unsealed position wherein fluid communication from is pressure chamber is allowed.

The suspension component of the preceding clause, wherein the fastener is movable to a third position wherein the fastener is free from the first suspension element.

The suspension component of any preceding clause, wherein, in the third position of the fastener, the vent seal is retained in the first suspension element.

The suspension component of any preceding clause, wherein the vent seal comprises a stop feature sized and shaped to retain the vent seal in the first suspension element.

The suspension component of any preceding clause, wherein the first suspension element comprises a fork lower assembly.

The suspension component of any preceding clause, wherein the first suspension element comprises a piston rod.

The suspension component of any preceding clause, wherein the first suspension element comprises an insert attachable to a piston rod.

The suspension component of any preceding clause, wherein the insert comprises an insert seal disposed between the insert and the piston rod.

The suspension component of any preceding clause, wherein the insert seal is shaped and sized to retain the insert in the piston rod.

The suspension component of any preceding clause, wherein the vent seal comprises a vent seal operation feature, the fastener comprises a fastener operation feature, and wherein the fastener operation feature is operable to move the vent seal from the second position to the first position via the vent seal operation feature.

The suspension component of any preceding clause, wherein the fastener is threadedly moveable between the first position and the second position.

A vent seal device for an air spring system, the vent seal device comprising: an air spring shaft assembly defining an axis; a vent seal movable along the axis between: a sealed position wherein the air spring shaft is sealed by the vent seal; and an unsealed position wherein the air spring shaft can fluidly communicate past the vent seal; and a fastener attachable to the vent seal device and movable along the axis between: a first position wherein the fastener is retained in the air spring shaft assembly and maintains the vent seal in the sealed position; and a second position wherein the fastener is retained in the air spring shaft assembly and facilitates movement of the vent seal to the unsealed position.

The vent seal device of the preceding clause, wherein the air spring shaft assembly comprises an insert attachable to an air spring shaft, and wherein the fastener is attachable to the insert.

The vent seal device of any preceding clause, wherein the fastener is movable to a third position wherein the fastener is free from the air spring shaft assembly.

The vent seal device of any preceding clause, wherein, in the third position of the fastener, the vent seal is retained in the air spring shaft assembly.

The vent seal device of any preceding clause, wherein the vent seal comprises a stop feature sized and shaped to retain the vent seal in the air spring shaft assembly.

The suspension component of any preceding clause, wherein the suspension component is a front fork for a bicycle.

The suspension component of any preceding clause, wherein the suspension component is a rear shock for a bicycle.

The suspension component of any preceding clause, wherein the suspension component is a seatpost for a bicycle.

A suspension component for a bicycle, the suspension component comprising: an upper assembly; a lower assembly movable relative to the upper assembly; a pressure chamber biasing the upper assembly apart from the lower assembly; a vent seal operable to control fluid communication from the pressure chamber; and a fastener attachable to a shaft assembly, wherein the fastener is movable between: a first position wherein the fastener is retained in the shaft and maintains the vent seal in a sealed position wherein fluid communication from the pressure chamber is blocked; and a second position wherein the fastener is retained in the shaft assembly and facilitates movement of the vent seal to an unsealed position wherein fluid communication from is pressure chamber is allowed.

The suspension component of the preceding clause, wherein at least a portion of the pressure chamber is disposed inside the shaft assembly.

The suspension component of any preceding clause, wherein the shaft assembly comprises an insert attachable to an air spring shaft, and wherein the fastener is attachable to the insert.

The suspension component of any preceding clause, wherein the fastener secures the lower assembly to the shaft assembly.

We claim:

1. A suspension component for a bicycle, the suspension component comprising:
a first suspension element;
a second suspension element movable relative to the first suspension element;
a pressure chamber biasing the first suspension element apart from the second suspension element;
a vent seal operable to control fluid communication from the pressure chamber; and
a fastener attachable to the first suspension element, wherein the fastener is movable between:
a first position wherein the fastener is retained in the first suspension element and maintains the vent seal in a sealed position wherein fluid communication from the pressure chamber is blocked; and
a second position wherein the fastener is retained in the first suspension element and facilitates movement of the vent seal to an unsealed position wherein fluid communication from is pressure chamber is allowed.

2. The suspension component of claim 1, wherein the fastener is movable to a third position wherein the fastener is free from the first suspension element.

3. The suspension component of claim 2, wherein, in the third position of the fastener, the vent seal is retained in the first suspension element.

4. The suspension component of claim 3, wherein the vent seal comprises a stop feature sized and shaped to retain the vent seal in the first suspension element.

5. The suspension component of claim 1, wherein the first suspension element comprises a fork lower assembly.

6. The suspension component of claim 1, wherein the first suspension element comprises a piston rod.

7. The suspension component of claim 1, wherein the first suspension element comprises an insert attachable to a piston rod.

8. The suspension component of claim 7, wherein the insert comprises an insert seal disposed between the insert and the piston rod.

9. The suspension component of claim 8, wherein the insert seal is shaped and sized to retain the insert in the piston rod.

10. The suspension component of claim 1, wherein the vent seal comprises a vent seal operation feature, the fastener comprises a fastener operation feature, and wherein the fastener operation feature is operable to move the vent seal from the second position to the first position via the vent seal operation feature.

11. The suspension component of claim 1, wherein the fastener is threadedly moveable between the first position and the second position.

12. A vent seal device for an air spring system, the vent seal device comprising:
an air spring shaft assembly defining an axis;
a vent seal movable along the axis between:
a sealed position wherein the air spring shaft is sealed by the vent seal; and
an unsealed position wherein the air spring shaft can fluidly communicate past the vent seal; and
a fastener attachable to the vent seal device and movable along the axis between:
a first position wherein the fastener is retained in the air spring shaft assembly and maintains the vent seal in the sealed position; and
a second position wherein the fastener is retained in the air spring shaft assembly and facilitates movement of the vent seal to the unsealed position.

13. The vent seal device of claim 12, wherein the air spring shaft assembly comprises an insert attachable to an air spring shaft, and wherein the fastener is attachable to the insert.

14. The vent seal device of claim 12, wherein the fastener is movable to a third position wherein the fastener is free from the air spring shaft assembly.

15. The vent seal device of claim 14, wherein, in the third position of the fastener, the vent seal is retained in the air spring shaft assembly.

16. The vent seal device of claim 15, wherein the vent seal comprises a stop feature sized and shaped to retain the vent seal in the air spring shaft assembly.

17. A suspension component for a bicycle, the suspension component comprising:
an upper assembly;
a lower assembly movable relative to the upper assembly;
a pressure chamber biasing the upper assembly apart from the lower assembly;
a vent seal operable to control fluid communication from the pressure chamber; and
a fastener attachable to a shaft assembly, wherein the fastener is movable between:
a first position wherein the fastener is retained in the shaft and maintains the vent seal in a sealed position wherein fluid communication from the pressure chamber is blocked; and
a second position wherein the fastener is retained in the shaft assembly and facilitates movement of the vent seal to an unsealed position wherein fluid communication from is pressure chamber is allowed.

18. The suspension component of claim 17, wherein at least a portion of the pressure chamber is disposed inside the shaft assembly.

19. The suspension component of claim 18, wherein the shaft assembly comprises an insert attachable to an air spring shaft, and wherein the fastener is attachable to the insert.

20. The suspension component of claim 17. wherein the fastener secures the lower assembly to the shaft assembly.
